(19) United States
(12) Patent Application Publication
(10) Pub. No.: US 2025/0139268 A1
(43) Pub. Date: May 1, 2025

(54) Output Privacy System

(71) Applicant: Varonis Systems Inc., New York, NY (US)

(72) Inventors: David Mizrachi, GIVATAIM (IL); Roni Yaari, JERUSALEM (IL); Hagai Langer, PETAH TIKVA (IL); John Eugene Neystadt, KFAR-SABA (IL)

(21) Appl. No.: 18/494,562

(22) Filed: Oct. 25, 2023

(51) Int. Cl. G06F 21/62

(52) U.S. Cl. CPC G06F 21/6218

(57) ABSTRACT

A system for controlling the privacy of data output by a computing system, particularly the privacy of data displayed on a display screen of a computer. Facial recognition is utilised to identify people in proximity to the output of the computer system and to control the output of the computer system dependent upon the identities of those people.

### TECHNICAL FIELD

The following disclosure relates to a system for controlling the output of a computer system depending on the identity of people in proximity to the computer system output device.

### BACKGROUND

Computers are often utilised to output confidential information, particularly on a display screen, which should not be viewable by everyone. In the context of the current disclosure “confidential” will be used to describe information which it is not appropriate for there to be free access to. That is, access to the information should be restricted in some way.

When computer systems are utilised in defined environments (for example an employee's office) the people capable of viewing the computer's screen can be controlled by the computer's user and hence that user can control access to information displayed on the computer's screen. However, when a computer is utilised in an uncontrolled environment, for example in a public space, the user may not be able to control who can view the computer screen and hence cannot control who has access to the information displayed on the computer screen. If that information is confidential it is not therefore possible to restrict access to the information to only the people who should be permitted to view it.

To control access to the information it is therefore necessary to restrict the locations a user can use their computer. However, that is disadvantageous in terms of work flexibility, particularly as access to even office environments may not be fully controlled. There is thus a requirement for a system which permits flexible use of a computer, while also preserving the confidentiality of displayed information. These principles may apply not only to information displayed on a screen, but also output via other output devices such as audio output from a speaker.

### SUMMARY

The invention is defined by the following disclosure and the claims.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding:

FIG. 1 shows an exemplary computing system;

FIG. 2 shows a flow chart of a method according to the current disclosure;

FIGS. 3 and 4 show flow of communications between elements of a system;

FIGS. 5 & 6 show exemplary situations of the current disclosure; and

FIG. 7 illustrates a computing device on which the technology may execute.

### DETAILED DESCRIPTION

The present disclosure relates to a computer system in which the output of information is controlled dependent on people who may be able to view or receive the output.

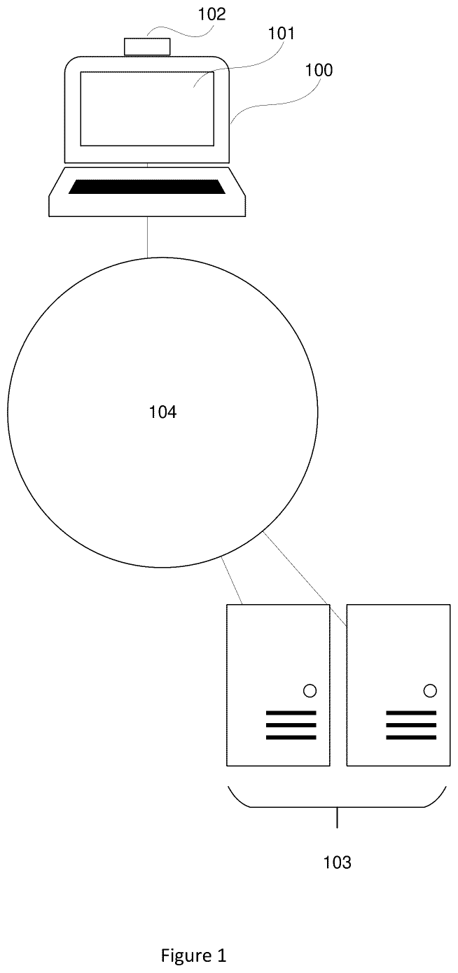

FIG. 1 shows a schematic diagram of a computer system in which an output privacy system according to the current disclosure may be implemented. Computer 100 is a user's computer, which may be a conventional computer with input devices, a display screen 101, and other outputs such as audio outputs. The computer 100 has or is connected to a camera 102 which is capable of viewing at least part of the area from which people can view the display screen 101. The computer 100 may be connected to a network 104 and to remote servers 103 which may provide functionality to the computer and/or serve data to the computer. In particular the remote servers 103 may provide data storage, an access control database, identification system, and a viewing control system. As will be appreciated each of these functions, and others, may be distributed between the one or more remote servers 103 and/or the computer 100. For example, in some configurations all functionality may be located in the computer 100, while in others the computer 100 may act largely as a dumb terminal and most functionality would be located in the remote servers 103.

An access control system is provided which links facial recognition data to access permissions. The access control database may contain identifiers for individuals and their associated access permissions, or may only link facial recognition data to access permissions such that individual identity information is not retained but their access permissions can be determined based on facial recognition data. For example, facial recognition data may be related to an access category which determines the type or level of information that they are permitted to access, but not to information which identifies the person.

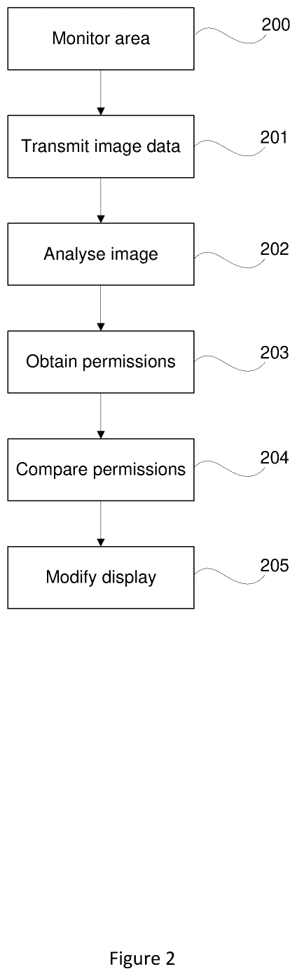

FIG. 2 shows a summary flow chart of a method of controlling output of information using the computing system of FIG. 1. At step 200 the camera 102 is utilised to monitor the area around the computer 100 from which people may be able to view the display screen 101. At step 201, image data from camera 102 is transmitted to an identification system which, at step 202, uses image analysis processes to extract facial recognition data for any people visible in the image data.

At step 203 the facial recognition data is transmitted to the access control system which returns access permissions associated with the facial recognition data. Where facial recognition data is not associated with any access permissions it may be assumed that the person has no access rights, or the lowest access rights permitted in the particular system.

At step 204 the returned access permissions are compared with access permissions associated with information being displayed by the computer screen. If this comparison shows that at least one person identified by the camera does not have sufficient access permissions to view the information being displayed, at step 205 the display is modified to prevent viewing of that data.

Step 205 may implement any appropriate method to prevent viewing of the information, for example, the entire screen may be locked, deactivated, darkened, or blurred, or only regions of the screen with information which failed the comparison may be changed, for example the relevant window may be minimised or closed, or the area may be blurred, darkened, or blanked. In addition, or instead, other actions such as displaying a warning message may be performed. For example, a warning message to the user could be displayed which obscures the information, thereby both preventing viewing by unauthorised parties, and alerting the user. The warning may allow the user to continue if they manually override the system's warning, or may prevent the user continuing until no unauthorised people are detected.

This disclosure is given primarily in relation to output on a computer screen, but as will be appreciated the principles are applicable to any type of output. For example, in the case of an audio output step 205 modifies the output in analogous ways to a visible output by pausing playback, muting it, reducing the volume, or distorting the sound.

The process of FIG. 2 may be repeated on a continuous or intermittent basis such that the system can react to changing surroundings. The repeat interval may be defined dependent on available processing and communication capacity, and the rate at which the people present in the surroundings may change. The interval may be static or dynamic.

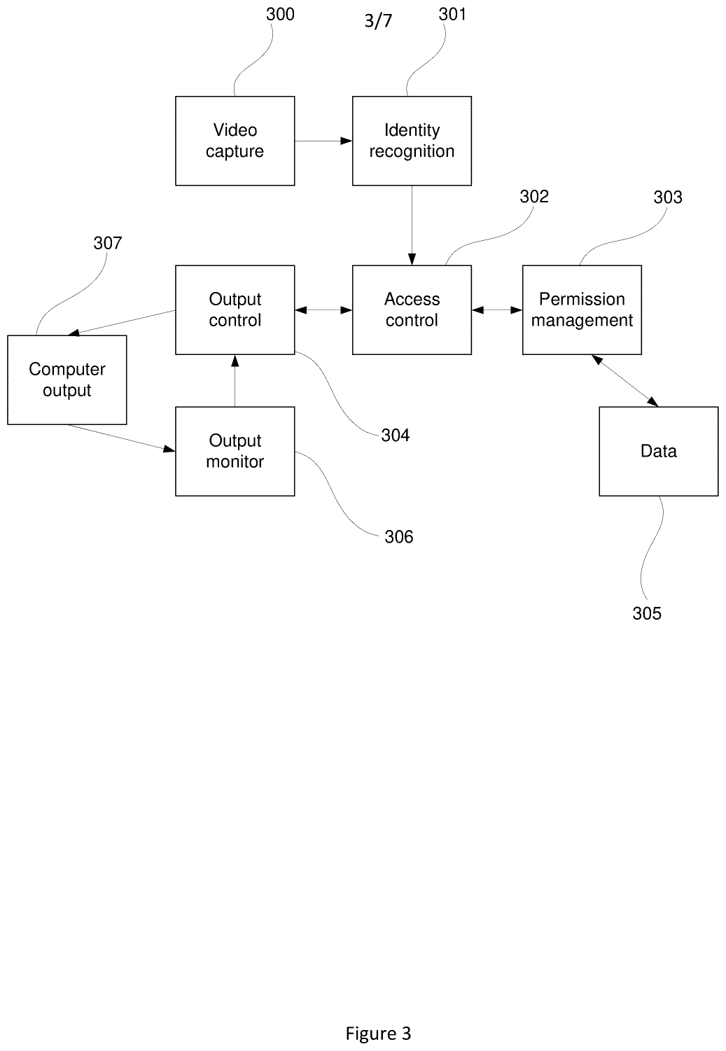

FIG. 3 shows an implementation of a data privacy system according to the current disclosure. The modules shown in FIG. 3 represent functional aspects of the system which may be implemented in the computing system of FIG. 1 to perform the method FIG. 2. The definitions of the modules are shown for convenience of explanation only and other divisions and implementations are also possible without departing from the principles of the current disclosure.

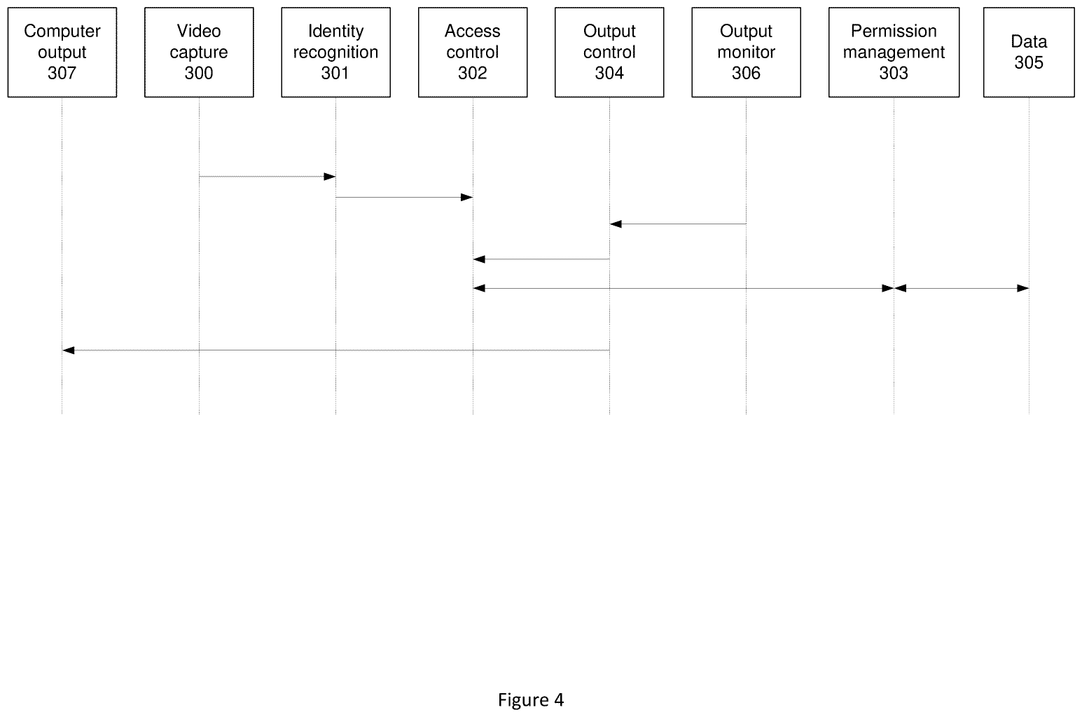

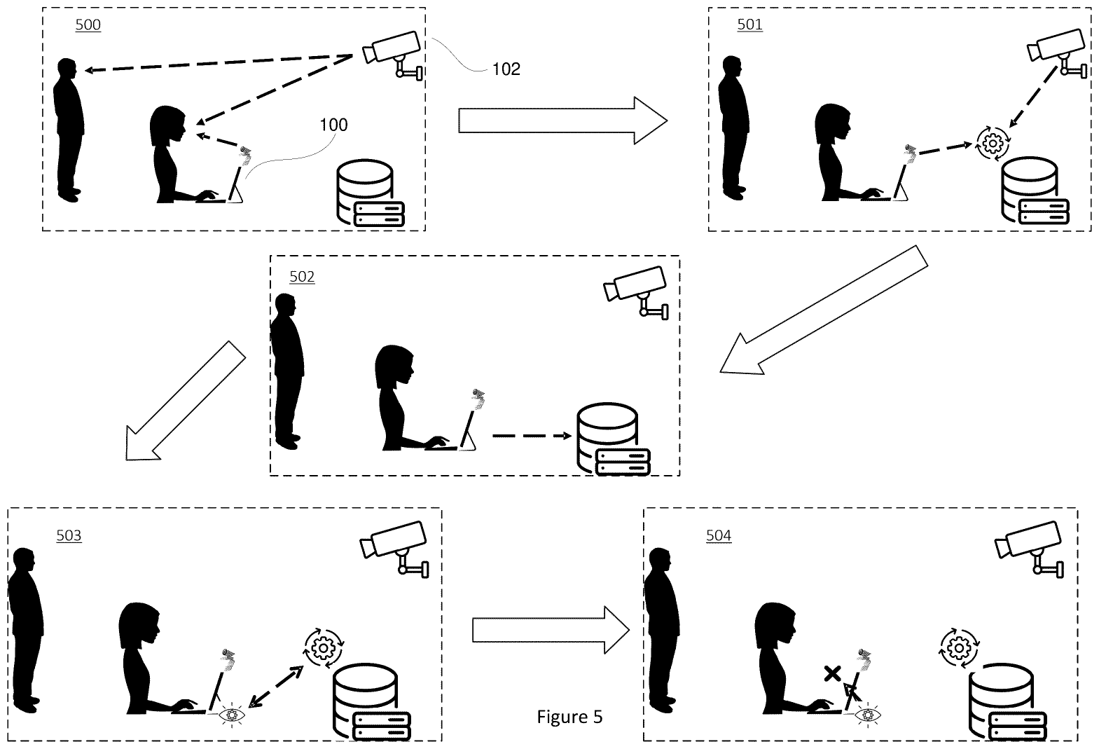

FIG. 4 shows an example flow of data between the modules of FIG. 2 to implement the method.

Video capture module 300 receives image data from the camera 102 associated with the computer 100 and transmits the image data to identity recognition module 301. Video capture module 300 may receive data from more than one camera. For example, a camera may be present on the user's computer 100 and if the user is in an organisation's meeting room there may be cameras in the room which can also provide image data. Identity recognition module 301 processes the image data to identify faces within the image. The output of the identity recognition module 301 is sufficient facial recognition data for the system to decide whether people in the image are entitled to view the information being displayed. This may comprise a person's actual identity, for example by comparing facial recognition data with facial recognition data stored for a company's employees, or in a database of people's access permissions which can be maintained by other systems. Alternatively the identity recognition module 301 may not output actual identity data, but rather may output a classification such as “is an employee”, “is not an employee”, or “is a contractor”. Such classification can then be utilised to decide whether the person is entitled to view the information or not. Further detail may also be provided, such as the person's group or role (e.g. finance, sales), and their level in the company, or any other relevant data.

The identity recognition module 301 may be configured to exclude the user of the computer in its analysis, or in other examples the user could also be included.

The output of the identity recognition module 301 is transmitted to access control module 302 which implements a decision system to decide whether the identified people are permitted to view the information.

The access control module is in communication with permission management module 303 and output control module 304. Output control module 302 provides an indication of the information being displayed by the computer. That indication may primarily comprise the identity of documents or data in the organisation database 305, which for example may be a document management system or file store. The output control module 304 may determine what is being output based on inputs from output monitor 306. Output monitor 306 may monitor requests to database 305 to determine what is being output, or may monitor other aspects of the computer's operation to determine what is being output. For example, opening or closing of files, or the addresses of web pages being displayed. The output monitor 306 may output a list of different information being displayed since more than one document or set of information may be being displayed. The output monitor 306 may notify the output control module 304 of the locations of the different outputs, for example by identifying which window each output is in.

The access control module 302 is also in communication with permission management module 303 which provides access to permissions for information being displayed by the computer. Those permissions may be retrieved dynamically from database 305, or the relevant storage area, or may be stored in permission management module 303 which is kept up to date with routine processes. The access control module 302 transmits an indication of the information being displayed to permission management module 303 and receives a response indicating the permissions applicable to that information. The permissions may be stored and indicated in any appropriate manner as is known in the field. For example, specific people may be identified as being allowed, or not access, or permissions may be defined for groups or categories of people.

The permissions returned from permission management module 303 maybe pre-stored permissions or may be generated dynamically for the information being output. The permissions may be generated by classifying each file based on its content, creator, location, or other known method of classifying files. The classification may be determined using methods such as rules based on the file information (e.g. location, creator), or based on an analysis of the file using patterns, regular expression analysis, or artificial intelligence processes such as a large language model. The analysis can be performed on a routine basis and the classifications stored in the permission management module 303 (or in another element of the system), or the analysis and classification can be performed when a user requests a file to display. The permission management module 303 may store the classification information itself, or the information may be stored in another element of the system. The permission management module 303 may also store permission information rather than classification information. In such a case when accessing a file the permission information can be obtained directly, rather than ascertaining the permissions from the classification when accessing the file. The classification and/or permission data can be stored in an external database, as metadata associated with or in the file itself, or as a digital rights management container which may also restrict access to the permission or classification data.

The permission management module 303 may also be responsible for maintaining and providing permissions related to the facial recognition data output by identity recognition module 301. As discussed above, permissions may be stored in relation to specific individuals, or groups or types. The principles applied in access control systems are equally applicable herein except the permissions are linked to facial recognition data.

Access control module 302 compares the permissions for each person identified by identity recognition module 301 to permissions for the information being displayed and decides whether the identified people are permitted to view the information. The access control module 302 may take its decision based on the identity with the minimum right to view information. Similarly, where multiple sets of information (for example, more than one document) are being displayed the access control module 302 system may base its analysis on the most secure information and apply that to all information, or its output may relate to each part of the display separately.

The access control module 302 provides an indication to output control module 304 whether elements of the information being displayed should not be displayed due to the identities detected. The output control module 304 modifies the display on computer output 307 appropriately to remove or otherwise obscure the information which should not be visible. As discussed above, the whole output may be blanked, or only the relevant regions may be blanked, or other techniques applied to prevent the information being viewed. Display of information in proximity to people who do not have permission to view the information is thereby prevented.

The processes of FIGS. 2 to 4 may be triggered by a user trying to open a document, or changing the information visible on a screen, or according to a predetermined schedule. If the process is triggered by the user accessing or displaying new information the output control module 304 may prevent such access or display before the information is displayed, and output a warning to the user (which as described above the user may be able to override, or not, depending on configuration).

The ordering of the steps discussed hereinbefore may be modified as appropriate to achieve an efficient implementation. In an example variation the system may monitor all people within view of the camera and maintain an indication of the restrictions applicable based on the people within view. For example, a maximum permission level may be maintained to define the maximum level of information that can be displayed based on the identities found. When a user requests a new document the request for the document may be sent together with an indication of the maximum permission level which can be displayed, which is used to determine whether the document can be opened. A similar comparison could be done when a user exposes a new window or information on the screen, which information can be compared to the maximum permission level before allowing display.

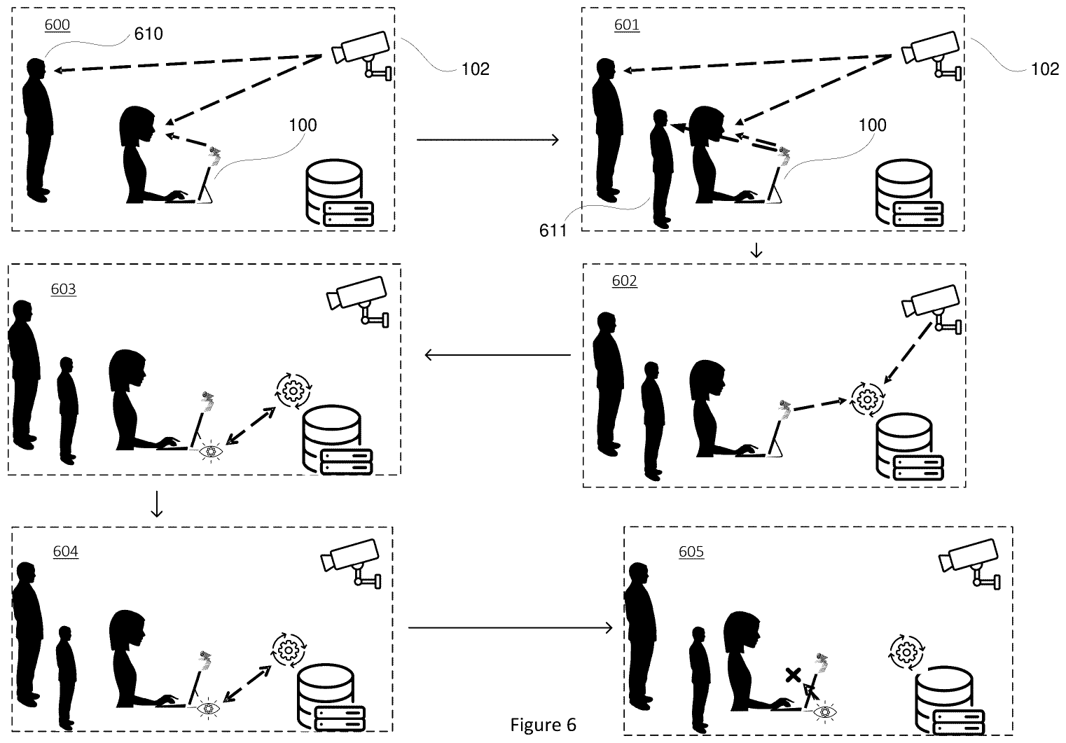

FIG. 5 shows an example scenario in which the currently disclosed systems may be utilised to maintain data privacy. At step 500 a user is shown using computer 100 and a third party is visible to camera 102. At step 501 the third party's identity is determined and a maximum view permission level calculated using the principles discussed above. It is determined all people have permission to view the information and therefore no action is taken.

In step 502 the user attempts to open a new file which has a more restrictive permission level and at step 503 the system determines that the people present do not have permission to view the information requested. At step 504 the system thus removes, hides, or obscures the information such that it cannot be seen. A warning may also be displayed.

FIG. 6 shows an alternative scenario in which in step 600 a first third party 610 has been identified with sufficient permission level to view the information being displayed on the computer 100. However, a second third party 611 also becomes visible to the camera 102. At steps 602 & 603 the system identifies the new person and determines their permission levels. In this example the new person has a lower permission and hence at steps 604 & 605 the system determines the content should not be visible and obscures the information in the display.

As has been described where the system cannot identify a person, or facial recognition data is not associated with a permission level, it may be assumed the person does not have permission to view the information. In an extension of this principle the system may identify that a person is present (for example from a body or head shape), but may not be able to recover any facial recognition information due to a poor image or the persons posture or direction in which they are facing. The identification of such people may also be categorised as the presence of a person without permission to view the data since the system has determined someone is present who might be able to view the information, but who cannot be cleared as having permission.

The principles discussed herein may be applied by the computer system in any location. For example, while the computer is being used in a public place, or an in office environment to ensure only staff allowed to view the information can view it. The principles may be applied to any format of output screen, for example the screen of a computer or a projected image, for example in a presentation or meeting room. In such cases cameras may be positioned to monitor the people present in the room and modify the display on the screen appropriately. Activation of the system could be dependent on the location of the computer. For example it could be deactivated when the computer is connected directly to an organisation's network as this indicates the computer is on the organisations premises, but activated when connected via a remote access connection.

In further examples, the output may be an audio output. In such cases the examples discussed above in which people cannot be identified due to facing away from the camera may be more important because a person does not have to be facing an output device to be able to hear the output, as opposed to a screen which requires they are facing the screen.

In further examples the system may also be configured to identify other objects capable of viewing the screen, such as mobile phones or camera devices. Based on detected such objects the system could obscure the information display as discussed in relation to identified people without sufficient permission or display a warning to the user that a device which may be capable of capturing images of the screen is in proximity.

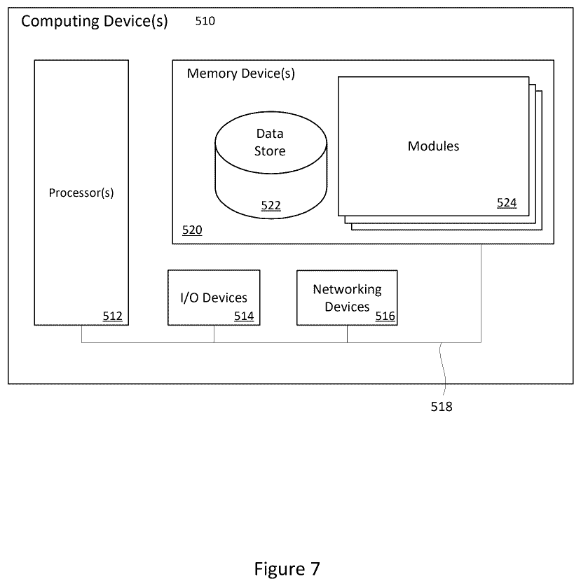

FIG. 7 illustrates a computing device 510 on which modules of this technology may execute. A computing device 510 is illustrated on which a high level example of the technology may be executed. The computing device 510 may include one or more processors 512 that are in communication with memory devices 520. The computing device 510 may include a local communication interface 518 for the components in the computing device. For example, the local communication interface 518 may be a local data bus and/or any related address or control busses as may be desired.

The memory device 520 may contain modules 524 that are executable by the processor(s) 512 and data for the modules 524. In one aspect, the memory device 520 may include a checkpoint manager, a migration management module, and other modules. In another aspect, the memory device 520 may include a network connect module and other modules. The modules 524 may execute the functions described earlier. A data store 522 may also be located in the memory device 520 for storing data related to the modules 524 and other applications along with an operating system that is executable by the processor(s) 512.

Other applications may also be stored in the memory device 520 and may be executable by the processor(s) 512. Components or modules discussed in this description that may be implemented in the form of software using high-level programming languages that are compiled, interpreted or executed using a hybrid of the methods.

The computing device may also have access to I/O (input/output) devices 514 that are usable by the computing devices. Networking devices 516 and similar communication devices may be included in the computing device. The networking devices 516 may be wired or wireless networking devices that connect to the internet, a LAN, WAN, or other computing network.

The components or modules that are shown as being stored in the memory device 520 may be executed by the processor(s) 512. The term “executable” may mean a program file that is in a form that may be executed by a processor 512. For example, a program in a higher level language may be compiled into machine code in a format that may be loaded into a random access portion of the memory device 520 and executed by the processor 512, or source code may be loaded by another executable program and interpreted to generate instructions in a random access portion of the memory to be executed by a processor. The executable program may be stored in any portion or component of the memory device 520. For example, the memory device 520 may be random access memory (RAM), read only memory (ROM), flash memory, a solid state drive, memory card, a hard drive, optical disk, floppy disk, magnetic tape, or any other memory components.

The processor 512 may represent multiple processors and the memory device 520 may represent multiple memory units that operate in parallel to the processing circuits. This may provide parallel processing channels for the processes and data in the system. The local interface 518 may be used as a network to facilitate communication between any of the multiple processors and multiple memories. The local interface 518 may use additional systems designed for coordinating communication such as load balancing, bulk data transfer and similar systems.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term “comprising” or “including” does not exclude the presence of other elements.

The term “computer” or “computing device” is used herein to refer to any computing device which can execute software and provide input and output to and from a user. For example, the term computer explicitly includes desktop computers, laptops, terminals, mobile devices, and tablets, as well as any similar or comparable devices. There is no intended difference between the terms computer, computing system or computing device, all of which fall within the same definition of computer.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable storage media or, more generally, a computer program product. The computer readable storage media, as the term is used herein, is not to be construed as storage in the form of transitory signals per se, such as radio waves or other freely propagating electromagnetic waves. The one or more computer readable storage media could be, for example, an electronic, magnetic, optical, electromagnetic, infrared, or semiconductor system, or a propagation medium for data transmission, for example for downloading the code over the Internet. Alternatively, the one or more computer readable storage media could take the form of one or more physical computer readable media such as semiconductor or solid state memory, magnetic tape, a removable computer diskette, a random access memory (RAM), a read-only memory (ROM), a rigid magnetic disc, and an optical disk.

A selection of examples is set out in the following numbered clauses.

1. A computer-implemented method for controlling the output of information from a computer, the method comprising: acquiring an image of an area proximate to the computer using a camera in communication with a processor of the computer; communicating the image to a computer-implemented image analysis system; by the image analysis system obtaining facial recognition information for at least one person in the image and determining security permissions for the at least one person based on the facial recognition information; determining security permissions for information being output, or to be output, by the computer; comparing the security permissions for the at least one person and for the information; and controlling the output of the information by the computer based on the comparison of security permissions.

2. A method according to clause 1, wherein the output of information is restricted due to the at least one person's security permissions being insufficient for the security permissions of the information.

3. A method according to clause 1 or clause 2, wherein the information and the security permissions for the information are obtained from a remote storage system.

4. A method according to any preceding clause, wherein the information is output by being displayed on a screen.

5. A method according to clause 4, wherein the output is controlled by modifying the appearance of at least part of the screen dependent on the comparison of security permissions.

6. A method according to clause 5, wherein the appearance of only a part of the screen where the information is being displayed is modified.

7. A method according to clause 5, wherein the appearance of areas in addition to the areas in which the information is being displayed are modified.

8. A method according to any of clauses 5 to 7, wherein the appearance is modified by blanking or blurring the relevant area of the screen.

9. A method according to any preceding clause, wherein a warning is output that people have been identified by the system who do not have permission to view the information.

10. A method according to clause 5, wherein a warning is output to a user of the computer, wherein the warning modifies the appearance of the display.

11. A method according to any preceding clause, wherein the at least one person does not include the user of the computer.

12. A method according to any preceding clause, wherein determining security permissions for the information being output comprises determining a classification of the information and determining permissions for that classification.

13. A method according to clause 12, wherein the classification is pre-determined.

14. A method according to clause 12, wherein the classification is determined as part of the step of determining security permissions for the information.

15. A method according to any of clauses 12 to 14, wherein the classification is determined based on the content of the information.

16. A method according to any of clauses 12 to 15, wherein the classification is stored in a database, in association with the information, or in a file containing the information.

17. A method according to any preceding clause, wherein all steps are performed at the computer outputting the information.

18. A method according to any of clauses 1 to 16, wherein the computer is connected to at least one remote computer system via a network and at least one of the steps of the method is performed at the least one remote computer.

19. A method according to clause 18, wherein at least the step of determining security permissions for information is performed at the remote computer.

20. A method according to any of clauses 1 to 16, wherein the step of determining security permissions for the at least one person based on the facial recognition information comprises transmitting the facial recognition information to a remote computer system.

21. A method according to any of clauses 1 to 16, wherein the image analysis system is located at a remote computer system.

22. A computer system comprising at least one computer, the computer system comprising one or more computer readable storage media storing program instruction and one or more processors which, in response to executing the program instructions, are configured to perform the method of any of clauses 1 to 19.

23. A computer system for controlling the output of information from a computer, comprising: one or more computer readable storage media storing program instructions and one or more processors which, in response to executing the program instructions, are configured to acquire an image of an area proximate to the computer using a camera in communication with a processor of the computer; communicate the image to a computer-implemented image analysis system; by the image analysis system obtain facial recognition information for at least one person in the image and determine security permissions for the at least one person based on the facial recognition information; determine security permissions for information being output, or to be output, by the computer; compare the security permissions for the at least one person and for the information; and control the output of the information by the computer based on the comparison of security permissions.

24. A computer system according to clause 23, wherein the output of information is restricted due to the at least one person's security permissions being insufficient for the security permissions of the information.

25. A computer system according to clause 23 or clause 24, wherein the information and the security permissions for the information are obtained from a storage system remote from the computer.

26. A computer system according to any of clauses 23 to 25, wherein the information is output by being displayed on a screen.

27. A computer system according to clause 26, wherein the output is controlled by modifying the appearance of at least part of the screen dependent on the comparison of security permissions.

28. A computer system according to clause 27, wherein the appearance of only a part of the screen where the information is being displayed is modified.

29. A computer system according to clause 27, wherein the appearance of areas in addition to the areas in which the information is being displayed are modified.

30. A computer system according to any of clauses 27 to 29, wherein the appearance is modified by blanking or blurring the relevant area of the screen.

31. A computer system according to any of clauses 23 to 30, wherein a warning is output that people have been identified by the system who do not have permission to view the information.

32. A computer system according to clause 23, wherein a warning is output to a user of the computer, wherein the warning modifies the appearance of the display.

33. A computer system according to any of clauses 23 to 32, wherein the at least one person does not include the user of the computer.

34. A computer system according to any of clauses 23 to 33, wherein determining security permissions for the information being output comprises determining a classification of the information and determining permissions for that classification.

35. A computer system according to clause 34, wherein the classification is pre-determined.

36. A computer system according to clause 34, wherein the classification is determined as part of determining security permissions for the information.

37. A computer system according to any of clauses 34 to 36, wherein the classification is determined based on the content of the information.

38. A computer system according to any of clauses 34 to 36, wherein the classification is stored in a database, in association with the information, or in a file containing the information.

39. A computer system according to any of clauses 23 to 38, wherein all steps are performed at the computer outputting the information.

40. A computer system according to any of clauses 23 to 38, wherein the computer is connected to at least one remote computer system via network and at least one of the steps of the method is performed at the least one remote computer.

41. A computer system according to clause 40, wherein at least the step of determining security permissions for information is performed at the remote computer.

42. A computer system according to any of clauses 23 to 41, wherein the step of determining security permissions for the at least one person based on the facial recognition information comprises transmitting the facial recognition information to a remote computer system.

43. A computer system according to any of clauses 23 to 42, wherein the image analysis system is located at a remote computer system.

44. A computer-implemented method for controlling the output of information from a computer, the method comprising: acquiring an image of an area proximate to the computer using a camera in communication with a processor of the computer; receiving an indication whether information being output, or to be output, by the computer can be output based on an analysis of the image; and controlling the output of the information by the computer based on the indication.

45. A method to clause 44, wherein the analysis is based on facial recognition.

46. A method according to clause 44 or clause 45, wherein the information is output by being displayed on a screen.

47. A method according to clause 44, wherein the output is controlled by modifying the appearance of at least part of the screen dependent on the comparison of security permissions.

48. A method according to clause 44, wherein the appearance of only a part of the screen where the information is being displayed is modified.

49. A method according to clause 44, wherein the appearance of areas in addition to the areas in which the information is being displayed are modified.

50. A method according to any of clauses 44 to 49, wherein the appearance is modified by blanking or blurring the relevant area of the screen.

51. A method according to any of clauses 44 to 50, wherein a warning is output that people have been identified by the system who do not have permission to view the information.

52. A method according to any of clauses 44 to 51, wherein a warning is output to a user of the computer, wherein the warning modifies the appearance of the display.

53. A method according to any of clauses 44 to 52, further comprising communicating the image to a computer-implemented image analysis system;
54. A method according to any of clauses 44 to 53, further comprising:
obtaining facial recognition information for at least one person in the image and determining security permissions for the at least one person based on the facial recognition information; determining security permissions for the information; and comparing the security permissions for the at least one person and for the information to determine the indication.

55. A method according to clause 54 wherein the information and the security permissions for the information are obtained from a remote storage system.

56. A method according to clause 54, wherein the at least one person does not include the user of the computer.

57. A method according to clause 54, wherein determining security permissions for the information being output comprises determining a classification of the information and determining permissions for that classification.

58. A method according to clause 57, wherein the classification is pre-determined.

59. A method according to clause 57, wherein the classification is determined as part of the step of determining security permissions for the information.

60. A method according to clause 57, wherein the classification is determined based on the content of the information.

61. A method according clause 57, wherein the classification is stored in a database, in association with the information, or in a file containing the information.

62. A computer system comprising at least one computer, the computer system comprising one or more computer readable storage media storing program instructions and one or more processors which, in response to executing the program instructions, are configured to configured to perform the method of any of clauses 44 to 61.

63. A computer for controlling the output of information, comprising: one or more computer readable storage media storing program instructions and one or more processors which, in response to executing the program instructions, are configured to: acquire an image of an area proximate to the computer using a camera in communication with a processor of the computer; receiving an indication whether information being output, or to be output, by the computer can be output based on an analysis of the image; and controlling the output of the information by the computer based on the indication.

64. A computer according to clause 63, wherein the analysis is based on facial recognition.

65. A computer according to clause 631 or clause 64, wherein the information is output by being displayed on a screen.

66. A computer according to clause 65, wherein the output is controlled by modifying the appearance of at least part of the screen dependent on the comparison of security permissions.

67. A computer according to clause 66, wherein the appearance of only a part of the screen where the information is being displayed is modified.

68. A computer according to clause 66, wherein the appearance of areas in addition to the areas in which the information is being displayed are modified.

69. A computer according to any of clause 66 to 68, wherein the appearance is modified by blanking or blurring the relevant area of the screen.

70. A computer according to any of clauses 63 to 69, wherein a warning is output that people have been identified by the system who do not have permission to view the information.

71. A computer according to any of clauses 65 to 70, wherein a warning is output to a user of the computer, wherein the warning modifies the appearance of the display.

72. A computer according to any of clauses 63 to 71, wherein the one or more processers are configured to:
communicate the image to a computer-implemented image analysis system;

73. A computer system according to clause 72, wherein the one or more processers are configured to: obtain facial recognition information for at least one person in the image and determine security permissions for the at least one person based on the facial recognition information; determine security permissions for the information; and compare the security permissions for the at least one person and for the information to determine the indication.

74. A computer system according to any of clauses 63 to 73 wherein the information and the security permissions for the information are obtained from a remote storage system.

75. A computer system according to any of clauses 63 to 74, wherein the at least one person does not include the user of the computer.

76. A computer system according to any of clauses 63 to 75, wherein determining security permissions for the information being output comprises determining a classification of the information and determining permissions for that classification.

77. A computer system according to clause 76, wherein the classification is pre-determined.

78. A computer system according to clause 76, wherein the classification is determined as part of the step of determining security permissions for the information.

79. A computer system according to clause 76, wherein the classification is determined based on the content of the information.

80. A computer system according to clause 76, wherein the classification is stored in a database, in association with the information, or in a file containing the information.

1. A computer-implemented method for controlling the output of information from a computer, the method comprising:
acquiring an image of an area proximate to the computer using a camera in communication with a processor of the computer;
communicating the image to a computer-implemented image analysis system;
by the image analysis system obtaining facial recognition information for at least one person in the image and determining security permissions for the at least one person based on the facial recognition information;
determining security permissions for information being output, or to be output, by the computer;
comparing the security permissions for the at least one person and for the information; and
controlling the output of the information by the computer based on the comparison of security permissions.

2. A method according to claim 1, wherein the output of information is restricted due to the at least one person's security permissions being insufficient for the security permissions of the information.

3. A method according to claim 1, wherein the information and the security permissions for the information are obtained from a remote storage system.

4. A method according to claim 1, wherein the information is output by being displayed on a screen.

5. A method according to claim 4, wherein the output is controlled by modifying the appearance of at least part of the screen dependent on the comparison of security permissions.

6. A method according to claim 5, wherein the appearance of only a part of the screen where the information is being displayed is modified.

7. A method according to claim 5, wherein the appearance of areas in addition to the areas in which the information is being displayed are modified.

8. A method according to claim 5, wherein the appearance is modified by blanking or blurring the relevant area of the screen.

9. A method according to claim 1, wherein a warning is output that people have been identified by the system who do not have permission to view the information.

10. A method according to claim 5, wherein a warning is output to a user of the computer, wherein the warning modifies the appearance of the display.

11. A method according to claim 1, wherein the at least one person does not include the user of the computer.

12. A method according to claim 1, wherein determining security permissions for the information being output comprises determining a classification of the information and determining permissions for that classification.

13. A method according to claim 12, wherein the classification is pre-determined, determined as part of the step of determining security permissions for the information, or determined based on the content of the information.

14-15. (canceled)

16. A method according to claim 12, wherein the classification is stored in a database, in association with the information, or in a file containing the information.

17. A method according to claim 1, wherein all steps are performed at the computer outputting the information.

18. A method according to claim 1, wherein the computer is connected to at least one remote computer system via a network and at least one of the steps of the method is performed at the least one remote computer.

19. A method according to claim 18, wherein at least the step of determining security permissions for information is performed at the remote computer.

20. A method according to claim 1, wherein the step of determining security permissions for the at least one person based on the facial recognition information comprises transmitting the facial recognition information to a remote computer system.

21. A method according to claim 1, wherein the image analysis system is located at a remote computer system.

22. A computer system comprising at least one computer, the computer system comprising one or more computer readable storage media storing program instruction and one or more processors which, in response to executing the program instructions, are configured to perform the method of claim 1.

23-80. (canceled)
